(19) United States
(12) Patent Application Publication
(10) Pub. No.: US 2025/0184605 A1
(43) Pub. Date: Jun. 5, 2025

(54) IMAGE PICKUP APPARATUS AND ITS CONTROL METHOD

(71) Applicant: CANON KABUSHIKI KAISHA, Tokyo (JP)

(72) Inventor: YUMI TAKAO, Chiba (JP)

(21) Appl. No.: 18/944,159

(22) Filed: Nov. 12, 2024

(30) Foreign Application Priority Data
Dec. 5, 2023 (JP) 2023-205176

(51) Int. Cl. H04N 23/67; G03B 13/36

(52) U.S. Cl. CPC H04N 23/672; G03B 13/36

(57) ABSTRACT

An image pickup apparatus includes a focus detector configured to perform focus detection in an imaging area to acquire a plurality of first defocus amounts different from one another in at least one of an image height, a focus detection direction, and an angle of an object; and a processor configured to perform focus control. The processor is configured to acquire first information indicating a relation between a defocus amount at a specific position in the imaging area and a defocus amount corresponding to the at least one in an area other than the specific position, acquire a plurality of second defocus amounts by using the plurality of first defocus amounts and the first information, and acquires a third defocus amount to be used for the focus control from among the plurality of second defocus amounts.

### BACKGROUND

### Technical Field

The present disclosure relates to an image pickup apparatus capable of autofocus (AF).

### Description of Related Art

Japanese Patent Laid-Open No. 2010-263568 discloses, as an image pickup apparatus configured to perform focus detection by a phase difference detection method using an image sensor such as a CMOS sensor, an image pickup apparatus configured to perform focus detection in a plurality of focus detection directions different from one another. In this image pickup apparatus, one defocus amount to be used for AF is obtained by comparing defocus amounts obtained in the plurality of focus detection directions. In addition, Japanese Patent Laid-Open No. 2016-090798 discloses a method of performing AF by using focus sensitivity corresponding to the image height in a case where different defocus amounts occur depending on the image height.

In a case where one defocus amount to be used for AF is determined by, for example, comparing defocus amounts obtained in a plurality of focus detection directions, like the image pickup apparatus of Japanese Patent Laid-Open No. 2010-263568, correct comparison and the like cannot be performed when there is defocus amount difference corresponding to the image height as in Japanese Patent Laid-Open No. 2016-090798. As a result, one accurate defocus amount is not obtained and AF cannot be performed at high accuracy.

### SUMMARY

An image pickup apparatus according to one aspect of the present disclosure includes a focus detector configured to perform focus detection in an imaging area to acquire a plurality of first defocus amounts different from one another in at least one of an image height, a focus detection direction, and an angle of an object; and a processor configured to perform focus control. The processor is configured to acquire first information indicating a relation between a defocus amount at a specific position in the imaging area and a defocus amount corresponding to the at least one in an area other than the specific position, acquire a plurality of second defocus amounts by using the plurality of first defocus amounts and the first information, and acquires a third defocus amount to be used for the focus control from among the plurality of second defocus amounts.

Further features of the disclosure will become apparent from the following description of embodiments with reference to the attached drawings.

### BRIEF DESCRIPTION OF THE DRAWINGS

FIG. 1 is a block diagram illustrating the configuration of an image pickup apparatus according to an example.

FIG. 2 is a diagram illustrating a pixel array of an image sensor in the example.

FIGS. 3A and 3B are a plan view and a cross-sectional view of a pixel in the example.

FIG. 4 is a diagram illustrating pupil division in the example.

FIG. 5 is another diagram illustrating pupil division in the example.

FIG. 6 is a diagram illustrating the relation between an image shift amount and a defocus amount in the example.

FIGS. 7A and 7B are diagrams illustrating focus sensitivity in the example.

FIGS. 8A to 8C are diagrams illustrating exemplary focus detection in the example.

FIGS. 9A to 9D are diagrams illustrating exemplary determination of a focus detection result in the example.

FIG. 10 is a flowchart illustrating AF processing in the example.

FIGS. 11A and 11B are diagrams illustrating an exemplary angle of an object.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

An example of the present disclosure will be described below with reference to the accompanying drawings.

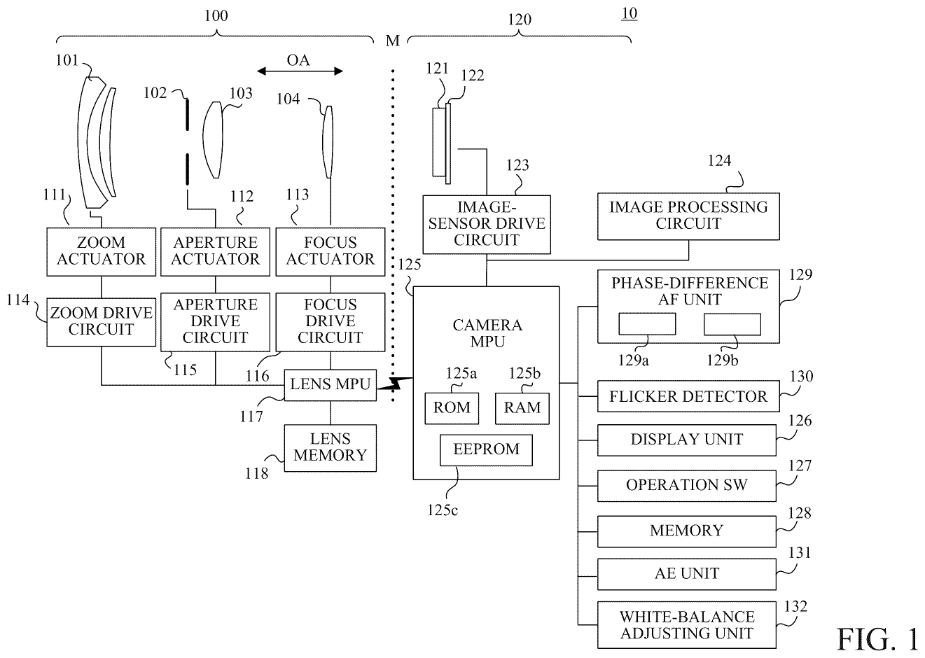

FIG. 1 illustrates the configuration of an image pickup system 10 including an image pickup apparatus (hereinafter referred to as camera body) 120 that is Example 1. A lens unit (interchangeable lens) 100 is detachably attached to the camera body 120 as a digital camera through a mount M illustrated with a dotted line in the drawing. The image pickup apparatus may be integrated with an imaging optical system. The image pickup apparatus is not limited to a digital camera but may be another image pickup apparatus such as a video camera.

The lens unit 100 includes a first lens group 101, an aperture stop 102, a second lens group 103, a focus lens group (hereinafter simply referred to as focus lens) 104 as a focus element, which constitute an imaging optical system, and a drive-control system. The imaging optical system acquires light from an object and forms an object image.

The first lens group 101 is disposed closest to the object and held to be movable in an optical axis direction in which an optical axis OA extends. The aperture stop 102 performs light quantity adjustment by changing its opening diameter and functions as a shutter for exposure time adjustment during still image pickup. The aperture stop 102 and the second lens group 103 are integrally movable in the optical axis direction and perform zooming by moving in coordination with the first lens group 101. The focus lens 104 is movable in the optical axis direction to perform focusing. Focus control (AF) is performed by controlling the position of the focus lens 104 in accordance with a focus detection result to be described later.

The drive-control system includes a zoom actuator 111, an aperture actuator 112, a focus actuator 113, a zoom drive circuit 114, an aperture drive circuit 115, a focus drive circuit 116, a lens MPU 117, and a lens memory 118. During zooming, the zoom drive circuit 114 drives the zoom actuator 111 to move the first lens group 101 and the second lens group 103 in the optical axis direction. The aperture drive circuit 115 drives the aperture actuator 112 to operate the aperture stop 102, thereby performing aperture operation and shutter operation.

During focusing, the focus drive circuit 116 drives the focus actuator 113 to move the focus lens 104 in the optical axis direction. The focus drive circuit 116 functions as a position detector configured to detect the current position (hereinafter referred to as focus position) of the focus lens 104 through the focus actuator 113.

The lens MPU 117 is a computer configured to execute calculation and processing related to the lens unit 100 and controls the zoom drive circuit 114, the aperture drive circuit 115, and the focus drive circuit 116. The lens MPU 117 is connected to a camera MPU 125 in the camera body 120 to perform communication therebetween through communication terminals of the mount M and communicates commands and data. For example, the lens MPU 117 notifies the camera MPU 125 of lens information in accordance with a request from the camera MPU 125. The lens information includes information such as the focus position, the position in the optical axis direction and the diameter of an exit pupil of the imaging optical system, and the position in the optical axis direction and the diameter of a lens area that restricts a light beam in the exit pupil.

The lens MPU 117 controls the zoom drive circuit 114, the aperture drive circuit 115, and the focus drive circuit 116 in accordance with a request from the camera MPU 125. The lens memory 118 stores optical information necessary for AF. The camera MPU 125 controls operation of the lens unit 100 by executing computer programs stored in a built-in nonvolatile memory and the lens memory 118.

The camera body 120 includes an optical lowpass filter 121, an image sensor 122, an image processing circuit 124, and the drive-control system. The optical lowpass filter 121 is provided to reduce false color and moire.

The image sensor 122 is constituted by a CMOS sensor and its peripheral circuits and photoelectrically converts the object image (optical image) formed through the imaging optical system and outputs an image pickup signal and a pair of focus detection signals (two-image signal). A plurality of image pickup pixels, m pixels in the lateral direction and n pixels in longitudinal direction (m and n are integers equal to or larger than two), are disposed in the image sensor 122. Each image pickup pixel includes a pair of focus detection pixels as described later and has a pupil dividing function capable of focus detection by a phase difference detection method.

The drive-control system includes an image-sensor drive circuit 123, the image processing circuit 124, the camera MPU 125, a display unit 126, an operation switch (SW) 127, a memory 128, a phase-difference AF unit 129, a flicker detector 130, an AE unit 131, and a white-balance (WB) adjusting unit 132. The image-sensor drive circuit 123 controls electric charge accumulation and signal readout in the image sensor 122, A/D converts the image pickup signal and the pair of focus detection signals output from the image sensor 122, and outputs the converted signals to the image processing circuit 124 and the camera MPU 125. The image processing circuit 124 generates image data by performing image processing such as γ conversion, color interpolation processing, and compression encoding processing on the digital image pickup signal from the image-sensor drive circuit 123.

The camera MPU 125 as a control unit is a computer configured to execute calculation and processing related to the camera body 120 and controls the image-sensor drive circuit 123, the image processing circuit 124, the display unit 126, the phase-difference AF unit 129, the flicker detector 130, the AE unit 131, and the WB adjusting unit 132. The camera MPU 125 is connected to the lens MPU 117 to perform communication therebetween through the communication terminals of the mount M and communicates commands and data with the lens MPU 117. For example, the camera MPU 125 requests the lens information and the optical information from the lens MPU 117 and also requests driving of the lenses 101 and 104 and the aperture stop 102. The camera MPU 125 receives the lens information and the optical information transmitted from the lens MPU 117.

The camera MPU 125 includes a ROM 125a storing various computer programs, a RAM 125b storing variables, and an EEPROM 125c storing various parameters. The camera MPU 125 executes various kinds of processing including AF processing to be described later in accordance with the computer programs stored in the ROM 125a. The camera MPU 125 generates two-image data from the pair of digital focus detection signals from the image-sensor drive circuit 123 and outputs the generated two-image data to the phase-difference AF unit 129.

The display unit 126 is constituted by an LCD or the like and displays information on an image pickup mode, a preview image before image pickup, a confirmation image after image pickup, a focus state, and the like. The operation SW 127 includes a power switch, a release (image pickup instruction) switch, a zoom switch, an image pickup mode selection switch, and the like. The memory 128 is a flash memory detachably attached to the camera body 120 and records record images obtained by image pickup.

The phase-difference AF unit 129 as a focus detector performs focus detection by using the two-image data generated by the camera MPU 125. The image sensor 122 photoelectrically converts a pair of optical images formed by light beams having passed through a pair of pupil areas different from each other in the exit pupil of the imaging optical system and outputs the pair of focus detection signals. The phase-difference AF unit 129 performs correlation calculation on the two-image data generated from the pair of focus detection signals by the camera MPU 125 to calculate an image shift amount that is the phase difference therebetween, and calculates (acquires) a defocus amount as focal point information from the image shift amount. The camera MPU 125 calculates a drive amount of the focus lens 104 based on the defocus amount calculated by the phase-difference AF unit 129 and transmits a focus control command including the drive amount to the lens MPU 117.

In this manner, on-sensor phase difference AF using output from the image sensor 122 is performed without using an AF sensor dedicated for focus detection in the present example. The phase-difference AF unit 129 in the present example includes an acquisition unit 129a configured to acquire the two-image data and a calculation unit 129b configured to calculate the defocus amount. At least one of the acquisition unit 129a and the calculation unit 129b may be provided in the camera MPU 125.

The flicker detector 130 detects flicker from flicker detection image data obtained from the image processing circuit 124. The camera MPU 125 performs control to adjust the exposure amount so that influence of the detected flicker decreases.

The AE unit 131 performs exposure control (AE) by performing exposure metering using AE image data obtained from the image processing circuit 124. Specifically, the AE unit 131 acquires luminance information on the AE image data and calculates image pickup conditions including aperture value, shutter speed (shutter time), and ISO sensitivity based on the difference between an exposure amount obtained from the luminance information and an exposure amount set in advance. Then, the aperture value, the shutter speed, and the ISO sensitivity are controlled to the calculated values, thereby performing AE.

The WB adjusting unit 132 calculates WB of WB adjustment image data obtained from the image processing circuit 124 and adjusts weights of RGB colors in accordance with the difference between the calculated WB and predetermined appropriate WB, thereby performing WB adjustment.

The camera MPU 125 may perform processing of detecting an object such as a human face in image data obtained from the image processing circuit 124. The camera MPU 125 can select, in accordance with the position and size of the detected object, an image height range for performing phase difference AF, AE, and WB adjustment.

### Image Sensor 122

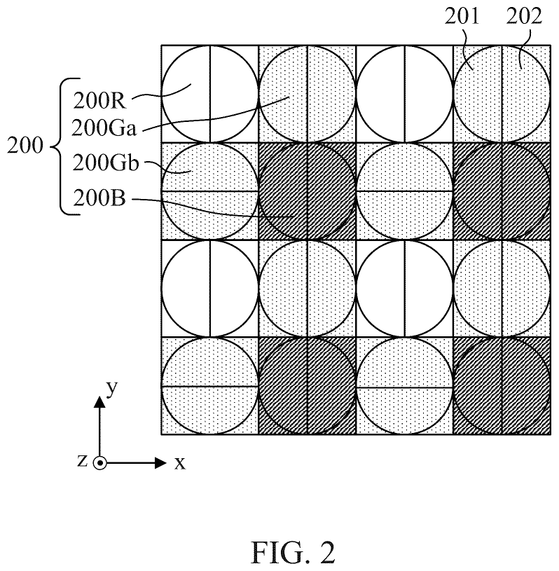

FIG. 2 illustrates a pixel array on an imaging plane of the image sensor 122 as a two-dimensional CMOS sensor in the present example. The array of image pickup pixels in a 4×4 range is illustrated. One pixel group 200 including 2×2 image pickup pixels includes a pixel 200R having spectral sensitivity to R (red) and disposed in the upper left, pixels 200Ga and 200Gb having spectral sensitivity to G (green) and disposed in the upper right and the lower left, and a pixel 200B having spectral sensitivity to B (blue) and disposed in the lower right. Each image pickup pixel is constituted by a first focus detection pixel 201 and a second focus detection pixel 202. The first focus detection pixel 201 and the second focus detection pixel 202 are disposed in the horizontal direction in the pixels 200R, 200Ga, and 200B, and the first focus detection pixel 201 and the second focus detection pixel 202 are disposed in the vertical direction in the pixel 200Gb.

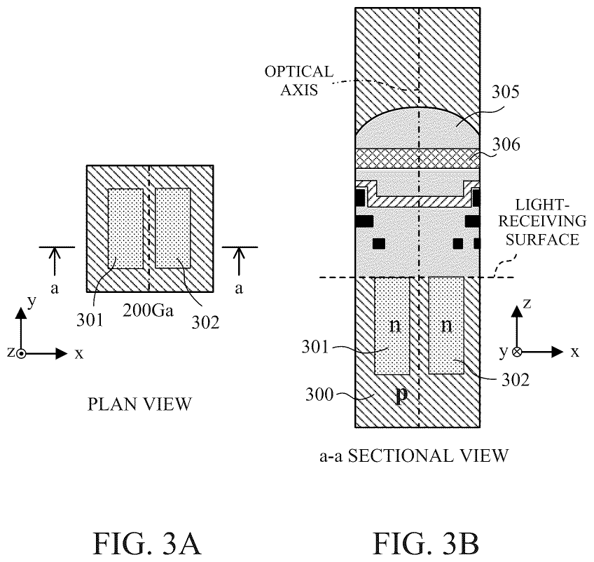

FIG. 3A illustrates the pixel 200Ga when viewed from an incident side (+z side) of the image sensor 122, and FIG. 3B illustrates a pixel structure when a section a-a of the pixel 200Ga in FIG. 3A is viewed from the −y side. In the pixel 200Ga, a micro lens 305 for condensing incident light is formed on the incident side, and photoelectrical conversion units 301 and 302, which are divided into two in the x direction, are formed. The photoelectrical conversion units 301 and 302 correspond to the first focus detection pixel 201 and the second focus detection pixel 202, respectively.

The photoelectrical conversion units 301 and 302 may be p-i-n structure photodiodes in which an intrinsic layer is sandwiched between a p-type layer and an n-type layer or may be p-n junction photodiodes in which the intrinsic layer is omitted. A color filter 306 is formed between the micro lens 305 and the photoelectrical conversion units 301 and 302. The spectral transmittance of the color filter may be varied for each focus detection pixel, or the color filter may be omitted.

Two light beams incident on the pixel 200Ga through a pair of pupil areas are condensed through the micro lens 305, spectrally separated through the color filter 306, and then received by the photoelectrical conversion units 301 and 302. In each photoelectrical conversion unit, electrons and holes in pairs are generated in accordance with the quantity of the received light, separated by a depleted layer, and then the electrons as negative electric charge are accumulated in the n-type layer. The holes are discharged out of the image sensor 122 through the p-type layer connected to a non-illustrated constant-voltage source. The electrons accumulated in the n-type layer of each photoelectrical conversion unit are forwarded to a capacitance unit (FD) through a transfer gate and converted into a voltage signal.

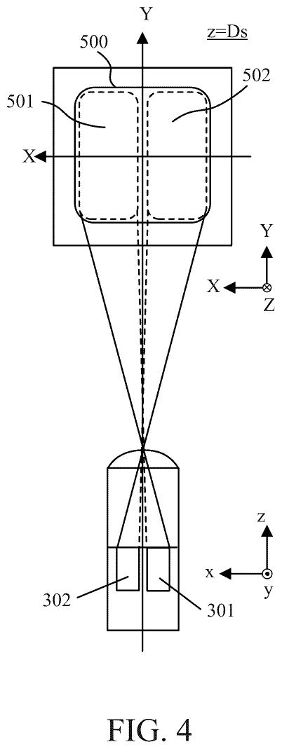

FIG. 4 illustrates the relation between the pixel structure illustrated in FIGS. 3A and 3B and pupil division. In FIG. 4, the lower part illustrates the pixel structure when the section a-a in FIG. 3A is viewed from the +y side, and the upper part illustrates a pupil plane at a pupil distance DS. In FIG. 4, the x and y axes of the pixel structure are inverted with respect to those in FIG. 3B for correspondence with the coordinate axes of the pupil plane. The pupil plane corresponds to an entrance pupil position of the image sensor 122. In the present example, the micro lens position in each pixel is offset (shrank) with respect to the center of the image sensor 122 so that the entrance pupils of the pixels overlap one another to form one entrance pupil of the image sensor 122. The pupil distance DS is the distance between the pupil plane and the imaging plane and referred to as sensor pupil distance in the following description.

As illustrated in FIG. 4, a first pupil area 501 of the first focus detection pixel 201 has a generally conjugate relation with the light-receiving surface of the photoelectrical conversion unit 301 having its barycenter decentered in the −x direction, through the micro lens. The first pupil area 501 is a pupil area through which a light beam that can be received by the first focus detection pixel 201 passes. The barycenter of the first pupil area 501 is decentered on the +X side on the pupil plane. In addition, a second pupil area 502 of the second focus detection pixel 202 has a generally conjugate relation with the light-receiving surface of the photoelectrical conversion unit 302 having its barycenter decentered in the +x direction, through the micro lens. The second pupil area 502 is a pupil area through which a light beam that can be received by the second focus detection pixel 202 passes. The barycenter of the second pupil area 502 is decentered on the −X side on the pupil plane. A pupil area 500 is a pupil area through which a light beam that can be received by the entire pixel 200Ga, as combination of the photoelectrical conversion unit 301 and the photoelectrical conversion unit 302 (the first focus detection pixel 201 and the second focus detection pixel 202), passes.

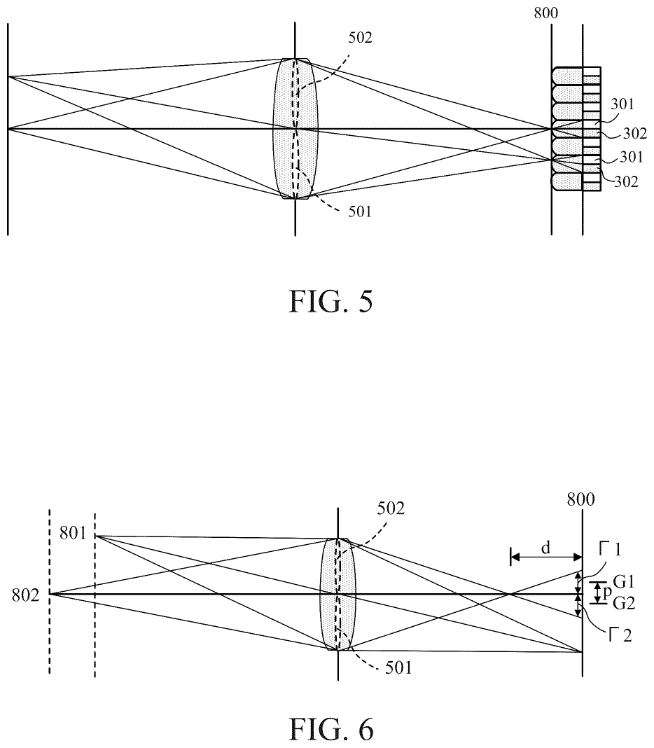

As illustrated in FIG. 5, light beams incident on the imaging optical system from an object (vertical line on the left side in the drawing) and having passed through the first pupil area 501 and the second pupil area 502, respectively, are incident on the image pickup pixels at angles different from one another and received by the photoelectrical conversion units 301 and 302. The pixels 200R, 200Ga, and 200B perform pupil division in the horizontal direction, and the pixel 200Gb performs pupil division in the vertical direction. The image pickup pixels each including the first focus detection pixel and the second focus detection pixel receive the light beams having passed through the first pupil area 501 and the second pupil area 502. The pair of focus detection signals are generated by combining output signals from the first focus detection pixel 201 and the second focus detection pixel 202, respectively, in each image pickup pixel. In addition, the image pickup signal with the resolution of an effective number of pixels N (=m×n) is generated by adding the output signals from the first focus detection pixel 201 and the second focus detection pixel 202 in each image pickup pixel. One of the pair of focus detection signals may be generated by subtracting the other focus detection signal from the image pickup signal.

In the present example, the first and second focus detection pixels are provided at each image pickup pixel of the image sensor 122, but two image pickup pixels may be used as the first and second focus detection pixels, or the first and second focus detection pixels may be provided at some image pickup pixels.

### Relation Between Defocus Amount and Image Shift Amount

FIG. 6 illustrates the relation between the defocus amount and the image shift amount of the two-image data. Reference number 800 indicates the imaging plane of the image sensor 122, and the pupil plane of the image sensor 122 is divided into the first pupil area 501 and the second pupil area 502. The defocus amount d is defined such that the magnitude of the distance from an imaging position of an object image (hereinafter referred to as image position) to the imaging plane 800 is |d| with the negative sign (d<0) for a short-focus state in which the image position is positioned on the object side of the imaging plane and the positive sign (d>0) for an over-focus state in which the image position is positioned on a side opposite the object side with respect to the imaging plane 800. The defocus amount d is zero for an in-focus state in which the image position is positioned on the imaging plane 800.

In FIG. 6, an object 801 is in the in-focus state (d=0) and an object 802 is in the short-focus state (d<0). The short-focus state (d<0) and the over-focus state (d>0) are collectively referred to as a defocus state (|d|>0).

In the short-focus state, light beams having passed through the first pupil area 501 and the second pupil area 502, respectively, among light beams from the object 802 are condensed once and then broadened to widths Γ1 and Γ2 centered at barycenter positions G1 and G2 of the light beams, and form blurred optical images on the imaging plane 800. These blurred images are received by the first focus detection pixel 201 and the second focus detection pixel 202 of each image pickup pixel on the imaging plane 800, and accordingly, a first focus detection signal and a second focus detection signal as the pair of focus detection signals are generated. The first and second focus detection signals are recorded as blurred images in which the object 802 is broadened to the blurring widths Γ1 and Γ2, respectively, at the barycenter positions G1 and G2 on the imaging plane 800. The blurring widths Γ1 and Γ2 increase substantially in proportion to increase of the magnitude |d| of the defocus amount d. Similarly, the magnitude |p| of an image shift amount p between the first and second focus detection signals (=difference G1−G2 between the barycenter positions of the light beams) increases substantially in proportion to increase of the magnitude |d| of the defocus amount d. The same applies in the over-focus state (d>0) as well although the first and second focus detection signals have an image shift direction opposite that in the short-focus state.

In the present example, barycenter difference of incident angle distribution between the first pupil area 501 and the second pupil area 502, respectively, is referred to as a base length. The relation between the defocus amount d and the image shift amount p at the imaging plane 800 is substantially similar to the relation of the base length with the sensor pupil distance. The magnitude of the image shift amount between the first and second focus detection signals increases as the magnitude of the defocus amount d increases, and thus, with this relation, the phase-difference AF unit 129 converts the image shift amount into the defocus amount by using a conversion coefficient calculated based on the base length.

In the following description, calculation of the defocus amount by using the pair of focus detection signals from a focus detection pixel with pupil division in the horizontal direction (lateral direction) like the pixel 200Ga is referred to as horizontal focus detection (first detection). In addition, calculation of the defocus amount by using the pair of focus detection signals from a focus detection pixel with pupil division in the vertical direction (longitudinal direction) like the pixel 200Gb is referred to as vertical focus detection (second detection).

### Focus Sensitivity

Focus sensitivity is an indicator of the relation between a unit movement amount of the focus lens 104 and a change amount of the image position that is the imaging position of an optical image, and in the present example, indicates the ratio of the change amount of the image position to the unit movement amount of the focus lens 104. For example, the focus sensitivity is one in a case where the change amount of the image position is 1 mm when the focus lens 104 is moved by the unit movement amount of 1 mm, and the focus sensitivity is two in a case where the change amount of the image position is 2 mm. However, the focus sensitivity may be another value, for example, the reciprocal of the above-described ratio.

The focus sensitivity may be the change amount of the image position for a particular unit amount in a case where the focus lens 104 is moved based on a monotonically increasing function. For example, in a case where the focus lens 104 is driven along the shape of a cam provided at a cam ring in cooperation with rotation of the cam ring, the focus sensitivity may be the change amount of the image position for an unit rotation angle of the cam ring, which is equivalent to the unit movement amount of the focus lens.

Typically, a drive amount X of the focus lens 104 is calculated by

$$X = d / S \qquad ( 1 )$$

where d represents the defocus amount and S represents the focus sensitivity.

A pulse number P of focus drive pulses supplied to the focus actuator 113 by a focus drive unit 109 in a case where the focus actuator 113 is a pulse-driven actuator such as a stepping motor is obtained by Expression (2) below.

$$P = X / m = d / ( mS ) \qquad ( 2 )$$

In Expression (2), m represents the movement amount of the focus lens 104 per focus drive pulse.

The phase-difference AF unit 129, the camera MPU 125, and the lens MPU 117 perform focus detection by the phase difference detection method as described below. The camera MPU 125 acquires the current position of the focus lens 104, the focus sensitivity S, and the movement amount m of the focus lens 104 per focus drive pulse from the lens MPU 117 in advance.

As described above, the phase-difference AF unit 129 calculates the image shift amount of the pair of focus detection signals (two-image data) acquired from the image sensor 122 and calculates (detects) the defocus amount from the image shift amount. The camera MPU 125 calculates the pulse number P of focus drive pulses by using Expression (2) described above and transmits a focus drive command including the pulse number P to the lens MPU 117.

The lens MPU 117 controls the focus drive circuit 116 so that focus drive pulses in the received pulse number P are supplied to the focus actuator 113. Accordingly, the focus lens 104 moves by the drive amount X (=d/S) and the in-focus state of the imaging optical system is obtained.

However, the interchangeable lens 100 of the present example includes an imaging optical system with a defocus amount d(h) that changes in accordance with an image height h. Thus, the camera MPU 125 calculates the drive amount X of the focus lens 104 by using the defocus amount d(h) corresponding to the image height h and the focus sensitivity S (h) corresponding to the image height h. Specifically, the drive amount X of the focus lens 104 is calculated by Expression (3) below. In addition, the pulse number P of focus drive pulses is calculated by Expression (4) below.

$$X = d ( h ) / S ( h ) \qquad ( 3 )$$

$$P = X / m = d ( h ) / ( mS ( h ) ) \qquad ( 4 )$$

### Defocus Amount Ratio

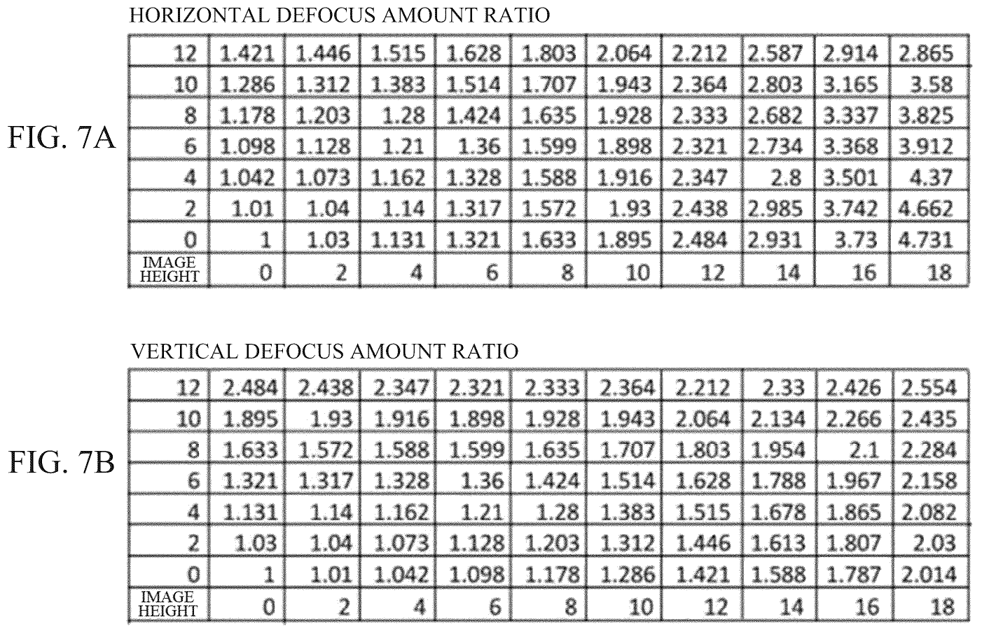

FIGS. 7A and 7B illustrate an exemplary ratio (hereinafter referred to as defocus amount ratio) of the defocus amount for each image height h in a case where the defocus amount d(h) at the center (the image height h=0) in an imaging area (imaging frame) of the imaging optical system is defined as one. FIG. 7A illustrates the defocus amount ratio in the horizontal focus detection (hereinafter also referred to as horizontal defocus amount ratio), and FIG. 7B illustrates the defocus amount ratio in the vertical focus detection (hereinafter also referred to as vertical defocus amount ratio). This example corresponds to the defocus amount ratio in the first quadrant of the imaging plane in a case where the image sensor 122 is a full-frame sensor. Image heights 0, 2, 4, . . . , 18 on the lowermost row in the drawing are the image height [mm] in the lateral direction, and image heights 0, 2, 4, . . . , 12 on the leftmost column are the image height [mm] in the longitudinal direction.

In a case where the horizontal focus detection is performed at the image height other than the center in the imaging area, the defocus amount d(h) is calculated by using the horizontal defocus amount ratio corresponding to the image height in FIG. 7A. For example, in FIG. 7A, the horizontal defocus amount ratio at the image height (16 mm laterally and 8 mm longitudinally) is 3.337. In a case where the vertical focus detection is performed at the image height other than the center in the imaging area, the defocus amount d(h) is calculated by using the vertical defocus amount ratio corresponding to the image height in FIG. 7B. For example, in FIG. 7B, the vertical defocus amount ratio at the image height (16 mm laterally and 8 mm longitudinally) is 2.1.

As understood from these diagrams, the defocus amount ratio of the imaging optical system increases as the position moves from the center toward the periphery. Moreover, the defocus amount ratio is different between focus detection directions (the lateral direction and the longitudinal direction).

Irrespective of the horizontal focus detection and the vertical focus detection, the defocus amount ratio for the same image height may be switched in accordance with the angle (edge angle) of an object detected in image data obtained from the image processing circuit 124. With this scheme, defocus amount difference corresponding to the image height can be corrected at higher accuracy.

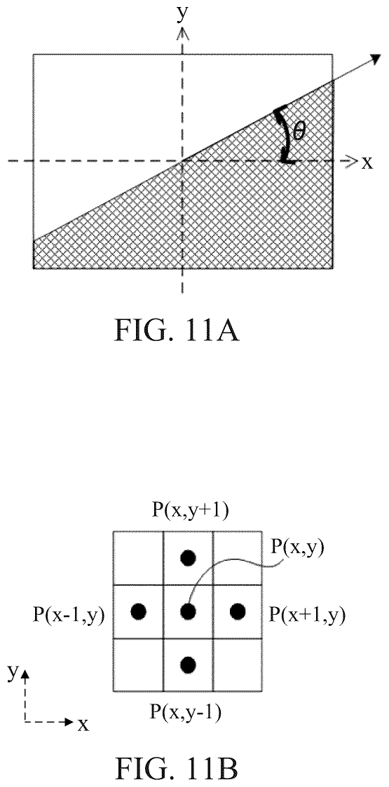

FIG. 11A illustrates an exemplary edge angle of an object. The edge angle of the object is the angle of an edge part of the object relative to an X axis as a horizontal axis on the imaging area as an XY surface. The angle of the edge part of the object, which is hatched in FIG. 11A, is 0. A method of detecting the edge angle will be described below with reference to FIG. 11B. The detection method in FIG. 11B is merely exemplary, and any other detection method may be used.

In FIG. 11B, the edge angle θ, which is the gradient direction of the coordinates (x, y) of pixels included in the edge part of the object, is calculated by Expression (5) below.

$$θ ( x , y ) = arc tan ( V ( x , y ) / H , x , y ) ) \qquad ( 5 )$$

The pixel coordinates (x, y) are orthogonal coordinates, where the horizontal right direction and the vertical upward direction are defined as positive directions, respectively. H(x,y) represents the horizontal contrast intensity at a specific frequency at the coordinates (x, y) and is given by Expression (6) below. P(α,β) represents the luminance value at pixel coordinates (α, β).

$$H ( x , y ) = P ( x + 1 , y ) - P ( x - 1 , y ) \qquad ( 6 )$$

Similarly, V(x, y) represents the vertical contrast intensity at the coordinates P(x, y) and is given by Expression (7) below.

$$V ( x , y ) = P ( x , y + 1 ) - P ( x , y - 1 ) \qquad ( 7 )$$

In this example, a demodulation filter at calculation of the contrast intensities H(x,y) and V(x, y) is (1, 0, −1). However, the filter may be replaced with any filter with which frequency components of the object can be detected.

The case of θ=90° corresponds to the defocus amount ratio in the horizontal focus detection illustrated in FIG. 7A, and the case of θ=0° corresponds to the defocus amount ratio in the vertical focus detection illustrated in FIG. 7B. The defocus amount ratio data tables illustrated in FIGS. 7A and 7B corresponding to the edge angle of the object may be held and the defocus amount ratio corresponding to the detected edge angle of the object for each image height may be read from the data tables and used.

As described above, the defocus amount ratio indicates the relation between the defocus amount at the center as a specific position on the imaging area and the defocus amount corresponding to at least one of the image height, the focus detection direction, and the object angle in a peripheral area other than the specific position. The specific position on the imaging area does not necessarily need to be the center but only needs to be a position that can be easily used as a reference of the defocus amount ratio.

Problem in Determination of One Focus Detection Result from Among a Plurality of Focus Detection Results

In the present example, the horizontal focus detection and the vertical focus detection are performed and a focus detection result used to drive the focus lens 104 is the result of one of the horizontal focus detection and the vertical focus detection. Furthermore, in a case where a plurality of defocus amounts at different image heights are obtained, the defocus amount obtained at a particular image height is used to drive the focus lens 104 in AF.

As described above with reference to FIGS. 7A and 7B, the defocus amount ratio is different for the same image height between the horizontal focus detection and the vertical focus detection. For example, at the image height (0, 12), the horizontal defocus amount ratio increases by a factor of 1.421 relative to that at the center, but the vertical defocus amount ratio increases by a factor of 2.484. In this case, the defocus amount obtained in the vertical focus detection is constantly larger than the defocus amount obtained in the horizontal focus detection. For example, in such a situation, in a case where an algorithm prioritizing the close distance side is applied to select a focus detection result used to drive the focus lens 104, only the defocus amount obtained in the vertical focus detection is selected. Furthermore, for example, in a case where the average of focus detection results is calculated, the average value of defocus amounts largely different from one another is obtained. Thus, it is disadvantageous to perform AF by selecting one focus detection result from among a plurality of focus detection results with different defocus amount ratios.

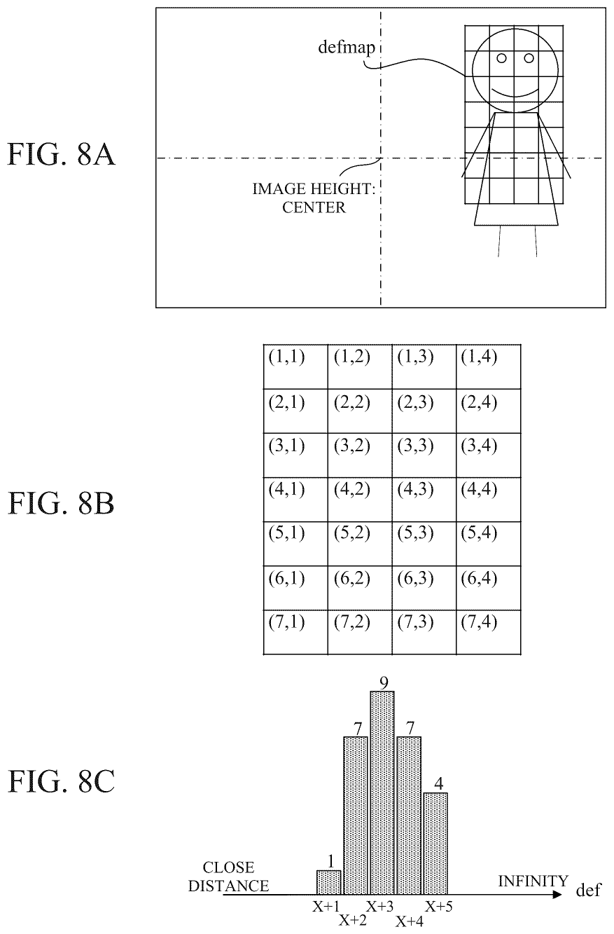

FIG. 8A illustrates an example in which, in focus detection, defmap as a map illustrating the defocus amount at a plurality of image heights is loaded for a person as an object and used to determine one defocus amount (hereinafter referred to as use defocus amount) to be used for AF. The defmap illustrates, for example, the defocus amount acquired in 28 focus detection areas (coordinates (1, 1) to (7, 4)) in 4 horizontal×7 vertical arrangement, which are set on the human face and torso as illustrated in FIG. 8B.

FIG. 8C illustrates a histogram of the defocus amount (for example, horizontal focus detection result) in the above-described 28 focus detection areas. The horizontal axis represents def ranges x+1, x+2, x+3, x+4, and x+5 as ranges of the defocus amount, and the vertical axis represents the number of focus detection areas in which the defocus amount is included in each def range. According to the diagram, with x=0, the number of focus detection areas in which the defocus amount is in a def range (for example, equal to or larger than 0.5 Fδ and smaller than 1.5 Fδ) centered at 1 Fδ is one, and the number of focus detection areas in which the defocus amount is in either of def ranges centered at 2 Fδ and 4 Fδ is seven. In addition, the number of focus detection areas in which the defocus amount is in a def range centered at 3 Fδ is nine, and the number of focus detection areas in which the defocus amount is in a def range centered at 5 Fδ is seven. F represents the aperture value and & represents the diameter of permissible circle of confusion.

In FIG. 8C, a def range with the maximum number (mode value) of focus detection areas is x+3. Accordingly, the defocus amount for the person illustrated in FIG. 8A is likely to be in the range of x+3. Thus, for example, the average value of the defocus amount included in the range of x+3 is determined as the use defocus amount.

In this manner, by determining the use defocus amount using a histogram, it is possible to expect effects such as preventing near-far conflicts and reducing influence of variance among defocus amounts in focus detection areas on a focus detection area for obtaining a definitive defocus amount.

However, in a case where such a histogram is used, the above-described defocus amount ratio corresponding to the image height becomes a problem.

For example, the focus detection area (1, 4) illustrated in FIGS. 8A and 8b is a focus detection area at the highest image height and the defocus amount ratio thereof is large. However, the focus detection area (6, 1) is a focus detection area at the image height closest to the center and the defocus amount ratio thereof is small. Such difference in the defocus amount ratio among image heights differs depending on the kind of the imaging optical system, and in the example of FIG. 7A, the focus detection area (1, 4) corresponds to the image height (16, 10) in FIG. 7A and the defocus amount ratio thereof is 3.165. The focus detection area (6, 1) corresponds to the image height (6, 0) in FIG. 7A and the defocus amount ratio thereof is 1.321. Moreover, at the same image height (14, 0) in FIGS. 7A and 7B corresponding to the same focus detection area (6, 4), the horizontal and vertical defocus amount ratios are 2.931 and 1.588 and thus different from each other.

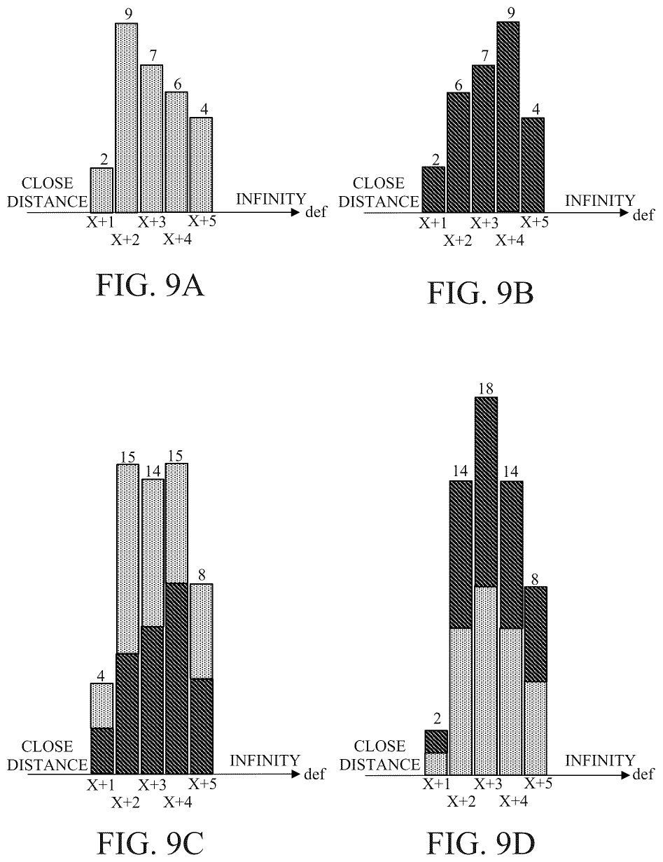

The defocus amount at each image height is calculated as a value multiplied by the defocus amount ratio. As a result, the original histogram illustrated in FIG. 8C is not obtained as illustrated in FIG. 9A, and a defocus amount uniquely determined based on the maximum number of focus detection areas in a histogram is different from the original value, or the defocus amount for the maximum number of focus detection areas is different between the horizontal focus detection and the vertical focus detection, in some cases.

FIG. 9A illustrates a histogram in the horizontal focus detection, and FIG. 9B illustrates a histogram in the vertical focus detection. To enhance the above-described effects such as reducing near-far conflicts and influence of variance among defocus amounts in focus detection areas, a histogram in FIG. 9C as combination of the histograms in FIGS. 9A and 9B may be obtained to perform focus detection. However, in this case as well, the defocus amount is different between the horizontal focus detection and the vertical focus detection without consideration of the defocus amount ratio corresponding to the image height, and as a result, a plurality of def ranges with the maximum number of focus detection areas are generated or a def range with the maximum number of focus detection areas is a false range.

Thus, in the present example, the use defocus amount that is appropriate for AF is determined from among a plurality of defocus amounts with different defocus amount ratios.

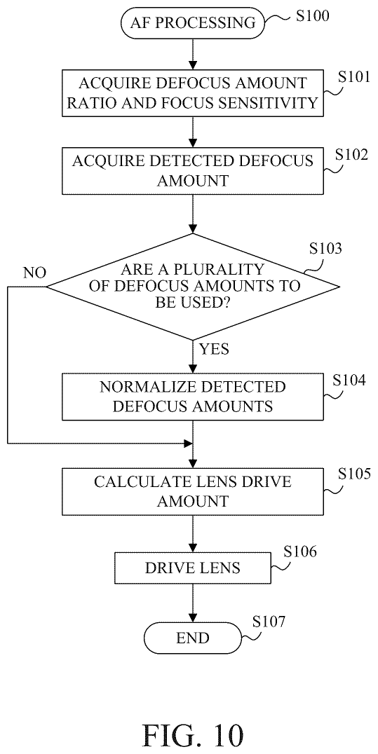

FIG. 10 illustrates a flowchart of AF processing (control method) executed by the camera MPU 125 in accordance with computer programs in the present example.

When image pickup preparation is instructed by an user operation on the release switch of the operation switch 127, the camera MPU 125 starts AF at step S100.

Subsequently at step S101, the camera MPU 125 acquires, from the lens MPU 117, information (first information) of defocus amount ratios different from one another in at least one of the image height, the focus detection direction, and the object angle, which is stored in the lens memory 118. The camera MPU 125 also acquires information (second information) of the focus sensitivity for each image height, which is stored in the lens memory 118. In this case, the information on defocus amount ratio and focus sensitivity may be acquired in a table data format, or information on coefficients of functions for calculating the defocus amount ratio and the focus sensitivity may be acquired. In other words, information on the defocus amount ratio and the focus sensitivity may be acquired in any manner.

Information on the defocus amount ratio only in some quadrants as illustrated in FIGS. 7A and 7B may be acquired, or information on the defocus amount ratio in all quadrants may be acquired. Moreover, information on the defocus amount ratio and the focus sensitivity for a plurality of models of interchangeable lens may be stored in the memory 128 in advance, and information corresponding to model information (such as lens ID) acquired from the lens MPU 117 may be acquired from the memory 128 by reading.

Subsequently at step S102, the camera MPU 125 causes the phase-difference AF unit 129 to acquire defocus amounts (first defocus amounts) in one or a plurality of focus detection areas.

Subsequently at step S103, the camera MPU 125 determines whether a plurality of defocus amounts different from one another in at least one of the image height, the focus detection direction, and the object angle are to be used in the current AF, and performs processing at step S104 if so. Otherwise, the camera MPU 125 performs processing at step S105. The camera MPU 125 proceeds to step S104 in a case where the use defocus amount is determined by using the above-described defocus amount histogram, the average value of a plurality of defocus amounts is determined as the use defocus amount, or a defocus amount value at the closest distance or at the infinity distance is determined as the use defocus amount.

At step S104, the camera MPU 125 normalizes the plurality of defocus amounts acquired at step S102. Specifically, the plurality of defocus amounts acquired at step S102 are divided by the corresponding defocus amount ratio of the image height, the focus detection direction, or the object angle. Accordingly, each defocus amount becomes a defocus amount (second defocus amount) normalized to a value corresponding to a defocus amount at the center where the defocus amount ratio is one, and the plurality of normalized defocus amounts can be compared irrespective of the image height, the focus detection direction, and the object angle.

As a result, a histogram illustrated in FIG. 9D is obtained as a histogram of the normalized defocus amounts, and the camera MPU 125 determines, as the use defocus amount (third defocus amount), a normalized defocus amount in the def range x+3 for the maximum number of focus detection areas.

Subsequently at step S105, the camera MPU 125 calculates (acquires) a drive amount of the focus lens 104 by using the use defocus amount determined at step S104 or one defocus amount acquired at step S102. Specifically, the pulse number P of focus drive pulses is calculated by using Expressions (3) and (4) described above. In a case where step S104 has been passed, the defocus amount d(h) and the focus sensitivity S(h) at the center (h=0) may be used in Expressions (3) and (4). In a case where step S104 has not been passed, the defocus amount d(h) and the focus sensitivity S(h) in Expressions (3) and (4) may be values corresponding to the image height at which the defocus amount is acquired.

Subsequently at step S106, the camera MPU 125 transmits a focus drive command including the drive amount calculated at step S105 to the lens MPU 117. The lens MPU 117 controls the focus drive unit 109 based on the received focus drive command, thereby driving the focus lens 104.

Thereafter, the camera MPU 125 ends the present processing at step S107.

Through the above-described AF processing, one accurate defocus amount to be used for AF can be obtained from among a plurality of defocus amounts different from one another in at least one of the image height, the focus detection direction, and the object angle (for example, the image height and the focus detection direction, or the image height and the object angle).

Although the present example is described above for a case where focus control to move a focus lens as the focus element in the optical axis direction is performed, focus control to move an image sensor as the focus element in the optical axis direction may be performed.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions. According to the present disclosure, it is possible to obtain one accurate defocus amount from among a plurality of defocus amounts different from one another in at least one of an image height, a focus detection direction, and an object angle.

This application claims priority to Japanese Patent Application No. 2023-205176, which was filed on Dec. 5, 2023, and which is hereby incorporated by reference herein in its entirety.

What is claimed is:

1. An image pickup apparatus comprising:
a focus detector configured to perform focus detection in an imaging area to acquire a plurality of first defocus amounts different from one another in at least one of an image height, a focus detection direction, and an angle of an object; and
a processor configured to perform focus control,
wherein the processor is configured to:
acquire first information indicating a relation between a defocus amount at a specific position in the imaging area and a defocus amount corresponding to the at least one in an area other than the specific position,
acquire a plurality of second defocus amounts by using the plurality of first defocus amounts and the first information, and
acquires a third defocus amount to be used for the focus control from among the plurality of second defocus amounts.

2. The image pickup apparatus according to claim 1, wherein the processor is configured to:
acquire, as the first information, information indicating the relation between the defocus amount at the specific position and the defocus amount corresponding to the image height and the focus detection direction in the area other than the specific position, and
acquire the plurality of second defocus amounts by using a) the plurality of first defocus amounts different from one another in at least one of the image height and the focus detection direction and b) the first information.

3. The image pickup apparatus according to claim 1, wherein the processor is configured to:
acquire, as the first information, information indicating the relation between the defocus amount at the specific position and the defocus amount corresponding to the image height and the angle of the object in the area other than the specific position, and
acquire the plurality of second defocus amounts by using a) the plurality of first defocus amounts different from one another in at least one of the image height and the angle of the object and b) the first information.

4. The image pickup apparatus according to claim 1, wherein the first information is information on a ratio of a defocus amount in the area other than the specific position to the defocus amount at the specific position.

5. The image pickup apparatus according to claim 1, wherein the processor is configured to acquire the plurality of second defocus amounts by normalizing the plurality of first defocus amounts by using the first information.

6. The image pickup apparatus according to claim 1, wherein the processor is configured to acquire the third defocus amount from among a second defocus amount as a mode value of a histogram of the plurality of second defocus amounts, an average value of the plurality of second defocus amounts, and a value at a closest distance or at an infinity distance among the plurality of second defocus amounts.

7. The image pickup apparatus according to claim 1, wherein the processor is configured to:
acquire second information indicating a relation between a unit movement amount of a focus element to be moved in the focus control and a change amount of position of an object image, and
acquire a drive amount of the focus element in the focus control by using the third defocus amount and the second information.

8. The image pickup apparatus according to claim 1, wherein the image pickup apparatus allows attachment and detachment of an interchangeable lens, and
wherein the processor is configured to acquire the first information from the interchangeable lens.

9. A control method for an image pickup apparatus, the control method comprising the steps of:
performing focus detection in an imaging area to acquire a plurality of first defocus amounts different from one another in at least one of an image height, a focus detection direction, and an angle of an object;
acquiring first information indicating a relation between a defocus amount at a specific position on the imaging area and a defocus amount corresponding to the at least one in an area other than the specific position;
acquiring a plurality of second defocus amounts by using the plurality of first defocus amounts and the first information; and
acquiring a third defocus amount to be used for the focus control from among the plurality of second defocus amounts.

10. A non-transitory computer-readable storage medium storing a computer program that causes a computer of the image pickup apparatus to execute the control method according to claim 9.
